(19) United States
(12) Patent Application Publication
(10) Pub. No.: US 2001/0048004 A1
(43) Pub. Date: Dec. 6, 2001

(54) Dispenser for stick form solid edible foods, components therefor and methods of making the same

(76) Inventors: Vijay S. Malik, Kansas City, MO (US); Drake L. Koch, Kansas City, MO (US)

Correspondence Address: RICHARD L. MARSH, 4116 E. LATOKA, SPRINGFIELD, MO, 65809, US

(21) Appl. No.: 09/882,893

(22) Filed: Jun. 15, 2001

Related U.S. Application Data
(63) Continuation-in-part of application No. 29/124,812, filed on Jun. 12, 2000, now Pat. No. D444358.
Application No. 29/124,812 is a continuation-in-part of application No. 09/165,495, filed on Oct. 2, 1998, now Pat. No. 6,082,596.

(51) Int. Cl. G01F 11/00

(52) U.S. Cl. 222/390; 222/575

(57) ABSTRACT

A solid-foods dispenser receives a stick of solid edible material and dispenses the material in at least one ribbon of desired thickness. The solid-foods dispenser comprising an elongate housing having structural walls defining a chamber bounded by terminal ends wherein the chamber has an internal configuration generally corresponding to the configuration of the stick of material to be dispensed. A first closure is associated with a loading end of the dispenser and is adapted to be removingly engaged from the open terminal end of the housing. A second closure is positioned substantially adjacent the discharge end of the dispenser having a first portion of affixed to the housing and a second portion spaced from a bottom wall of the housing thus defining a discharge slot between second portion and said bottom wall of said chamber. A plunger is positioned in the housing and is movable from a position spaced from the second closure along the longitudinal axis of the dispenser to a position adjacent the second closure. The plunger has a mating face configured to mate with the internal face of the second closure. An advancing is associated with the first closure and is operable to move the plunger through the housing in the direction of the second closure.

### RELATED APPLICATION INFORMATION

This application is a Continuation-in-Part Application of U.S. Design Application 29/124,812, now allowed, which is a Continuation-in-Part Application of U.S. Ser. No. 09/165,495, now U.S. Pat. No. 6,082,596.

### BACKGROUND OF THE INVENTION

1. Field of the Invention

This invention relates to a dispenser adapted to receive stick form solid-foods edible material in one removable end thereof and dispense the material from another end thereof.

2. Prior Art Statement

It is known to provide a container for greasing a griddle wherein the container has tapered internal walls, a hinged lid carrying plunger on a threaded shaft for keeping the grease loosely held in the container in contact with the griddle through the open end of the container. For instance, see the U.S. Pat. No. 1,335,998 issued on Apr. 6, 1920 to A. St. Onge. St. Onge provides the tapered internal walls to tend to resist discharge of the contents by the plunger. Internal bosses for resisting discharge of material from the open end of the dispenser are shown in U.S. Pat. No. 3,162,884 issued on Dec. 29, 1964 to Bordwine, et al.

Additionally it is known to provide an extrusion head nozzle for a butter cutting and printing machine wherein the nozzle has an adjustable wedge shaped member on one wall thereof for varying the thickness of the extrudate, the nozzle having a bearing plate for attachment to the end of the dual extruder barrels. For instance, see the U.S. Pat. No. 1,463,407 issued on Jul. 31, 1923 to A. Sharp and G. Sharp. The bearing plate of the nozzle is curved on the surface facing the extruder screws and is adapted to provide only a transition zone between the extruder barrels and the rectangular butter slot.

Another known patent in the art claims a device for incrementally dispensing a spreadable foodstuff from an elongate housing defining a chamber open at both ends having dimensions sufficient to matingly enclose a butter stick, a means for advancing the stick and a spatula for slicing a quantity of the protruding foodstuff. There is no mechanical advantage means for advancing the stick but indicia in a slotted opening at the discharge end are provided for determining the thickness of the slice. For instance, see the U.S. Pat. No. 3,920,156 issued on Nov. 18, 1975 to Leslie E. Hicks.

It is known to provide a dispenser for butter or dough wherein the dispenser has a plunger for moving the butter or dough through the dispenser to allow for an incremental amount of butter or dough to be sliced from an open end thereof. The first three of the following dispensers have mechanical advantage for moving the material through the dispenser. For instance, see the U.S. Pat. No. 2,489,667 issued on Nov. 29, 1949 to Ruth E. Pennell, the U.S. Pat. No. 2,589,000 issued on Mar. 11, 1923 to Eugene Vani, the U.S. Pat. No. 2,845,707 issued on Aug. 5, 1958, to Benjamin Redmond, the U.S. Pat. No. 4,964,745 issued on Oct. 23, 1990 to Rosemary Deitz or the U.S. Design Pat. D347,366 issued on May 31, 1994 to Harmen, et al. These dispensers merely provide a pat of material or present the material at the end of the dispenser.

It is also known to provide a device for dispensing butter from one end of an elongated housing having a square interior cross section with internal projections on the one end to prevent accidental discharge of the stick and wherein the other end has a closure fitted thereon with mating flanges having a threaded shaft with a turning nut on one end and a pressure plate on the other end. The threaded shaft must be backed out entirely and the closure lifted from the mating flanges before inserting another stick. For instance, see the U.S. Pat. No. 2,980,247 issued on Apr. 18, 1961 to Robert R. DiGiantomasso.

It is further known to provide a solid-foods dispenser for dispensing the solid-foods in a ribbon of desired thickness comprising a rectangular elongated chamber open at both ends, a closure means carried by the housing adjacent one end for adjustably closing the one end thereof, the closure means defining an interior surface facing toward the chamber and a plunger positioned in the housing for moving along the longitudinal axis of the housing wherein the plunger is driven by a ratchet. For instance, see U.S. Pat. No. 3,750,913 issued on Aug. 7, 1973 to Heinz K. Wild. The adjustable closure means of Wild comprises the entirety of the one end and thus the entire force of extrusion is borne against the adjustable closure means causing same to become distorted or dislodged from the one end.

Those knowledgeable in the art will recognize that it is known to provide softened butter dispensed from pre-packaged envelopes through a closeable lip projecting from the lowermost edge of the front wall of the chamber wherein there is no mechanical advantage device and in fact requires squeezing the long dimension of the stick to dispense from a corner on the opposite side of the stick. For instance, see the U.S. Pat. No. 4,241,852 issued on Dec. 30, 1980 to Stanley J. Klem.

Additionally, it is known to provide a device for dispensing butter having a housing for containing the butter, a plunger mounted on a threaded screw shaft of substantially the same length as the housing wherein the shaft penetrates the stick from one end to the other. For instance, see the U.S. Pat. No. 4,544,083 issued on Oct. 1, 1985 to Matt Schroeder or the U.S. Design Pat. D315,083 to Anderson, et al.

A stick applicator comprising a ratchet driven plunger in a chamber wherein the chamber has a removable body tip having a portion thereof disposed at an angle to the longitudinal axis of the chamber is shown in U.S. Pat. No. 5,955,114 issued on Sep. 2,1 1999 to Jesus M. Llanos. The plunger cannot discharge substantially all of the material through the opening as the plunger does not conform to the removable body tip and thus a great deal of material is lost when cleaning the applicator.

Finally, it is known to provide a tubular device with a screw advancing mechanism on one end and removable die shapes on the opposite end, similar to the well-known cookie press, wherein a knife is used to slice off pats of solid edible material, such as butter, off the chosen end die shape. For instance, see the device of Shawn A. Stewart offered for sale on the web site of Michael I. Kroll at http//www.invention.com.

### SUMMARY OF THE INVENTION

Most prior art solid-foods dispensers comprising an elongate housing having structural walls defining a chamber bounded by terminal ends, wherein the chamber has an internal configuration generally corresponding to the configuration of the stick of material to be dispensed which generally present the solid material at one end of the dispenser from which a desired quantity such as a pat is cut with a knife. Another prior art dispenser apparently further provides different shaped discharges at the discharge end for defining different shaped pats. Yet another prior art dispenser further provides for dispensing a ribbon of material from one end of the dispenser under an adjustable plate fitted in a slot at the end of the chamber. All these dispensers either have no closed discharge end or have a discharge that is subject to the entire force of the material being forced against same. Therefore, it is an object of this invention to provide a solid food dispenser adapted to receive a stick of solid edible material through one end and dispense the material in at least one ribbon of desired thickness from the other end, the solid-foods dispenser comprising an elongate housing having structural walls defining a chamber bounded by terminal ends, the chamber having an internal configuration generally corresponding to the configuration of the stick of material to be dispensed, the dispenser further having a first closure means associated with a loading end of the dispenser adapted to be removingly engaged from the open terminal end of the housing, a second closure means carried by the housing, wherein the second closure means also has an internal face facing toward the chamber, a plunger means positioned in the housing and movable from a position spaced from the second closure means along the longitudinal axis of the dispenser to a position adjacent the second closure means, advancing means associated with the first closure means, the housing and the plunger means operable to move the plunger through the housing in the direction of the second closure means wherein the second closure means is positioned substantially adjacent the discharge end of the dispenser having a portion thereof fixed to the housing and a portion spaced from a bottom wall of the housing thus defining a discharge slot between the portion of the second closure and the bottom wall of the chamber, the portion fixed to an inside surface of the housing providing a buttress to support the structural walls of the discharge end.

It is another object of this invention to provide a solid-foods dispenser wherein the dispenser dispenses at least one ribbon of solid edible material having a width substantially greater than the thickness thereof through the discharge slot.

Yet another object of this invention is to provide a solid-foods dispenser wherein the discharge slot comprises multiple ports thereby dispensing a ribbon comprising multiple streams of solid edible material through the discharge slot, each stream having a width substantially equal to the thickness thereof wherein the multiple streams may be connected by a thin ribbon or may be separated by a space therebetween.

Yet another object of this invention is to provide a solid-foods dispenser wherein the multiple ports of the discharge slot are of like geometrical shape wherein the geometrical configurations may include quarter rounds, half rounds, square, split tubes, spaghetti shapes and/or an undulating shape.

Yet another object of this invention is to provide a solid-foods dispenser having a plunger moveable through the chamber, the plunger comprising a piston, a bearing washer and a retaining means, the piston being affixed with the retaining means to one end of a screw shaft of an advancing means, the screw shaft having a handle associated with the other end thereof and the bearing washer being disposed intermediate a pressure face of the piston and the terminal end of the screw shaft.

Those skilled in the art will appreciate that another object of this invention is to provide a solid-foods dispenser wherein the piston has a straight portion adjacent an open end thereof wherein the width thereof is substantially equal to the width of the major portion of the chamber and a breadth substantially equal to the breadth of the major portion of the chamber, the piston adapted for wiping surface contact with the interior surfaces of the major portion of the chamber.

Another significant object of this invention is to provide a solid-foods dispenser wherein the recess in the end of piston, when extruding the solid-foods through the discharges slot, forces the forward wiping edges of the piston against the walls of the chamber increasing the wiping force of the piston against the walls.

Yet a further object of this invention is to provide a solid-foods dispenser wherein a first closure means comprises an end cap having internal threads adapted to be threadingly engaged upon an open end of an elongate housing, the closure means receiving a screw shaft of an advancing means in a threaded hole in the center thereof, the internal threads having a multiple lead adapted for rapid removal of the first closure means from the elongate housing.

Still a further object of this invention is to provide a solid-foods dispenser wherein at least a portion of the structural walls of the chamber are not parallel from the loading end to the discharge end thereof.

Yet another object of this invention is to provide a solid-foods dispenser wherein the non-parallel structural walls of the chamber have a first non-parallel portion in the major portion thereof and a second non-parallel portion adjacent the loading end of the dispenser.

Yet further, an object of this invention is to provide a solid-foods dispenser wherein the non-parallel structural walls of the chamber in the major portion thereof are tapered wherein the taper of each structural wall is less than two degrees, preferably less than one degree and most preferably is one-half of one degree.

Still further, an object of this invention is to provide a solid-foods dispenser wherein the second non-parallel portion of the structural walls of the chamber are greater in width and/or breadth than the outside width and/or breadth of the piston throughout the loading end of the dispenser and wherein the second non-parallel portion may be tapered, straight or curved.

Skilled artisans will appreciate that another object of this invention is to provide a solid-foods dispenser adapted to receive a stick of solid edible material and dispense the material in a solid stream onto a substrate, the dispenser comprising an elongate housing having rectilinear structural walls bounded by terminal ends, one of the terminal ends defining a loading end of the dispenser, the one terminal end having removable closure means associated therewith, the other of the terminal ends defining a discharge end of the dispenser, the other terminal end having a fixed closure means formed integrally therewith defining a pressure plate having a discharge slot associated therewith.

Finally, it is an object of this invention is to provide a solid-foods dispenser wherein the removable closure means has an advance means associated therewith, the advance means having a plunger means on one end thereof positioned in the housing and movable along the longitudinal axis of the dispenser, the advance means forcing at least one solid stream of the stick of solid edible material through the discharge slot.

### BRIEF DESCRIPTION OF THE DRAWINGS

FIG. 1 is perspective view of the preferred embodiment of the solid-foods dispenser of this invention.

FIG. 2 is a an exploded view of the solid-foods dispenser of FIG. 1 having all parts in section view except a retaining screw and nut.

FIG. 3 is a section view taken along line 3-3 in FIG. 2 of the chamber of the solid-foods dispenser of FIG. 1.

FIG. 4 is a section view taken along line 4-4 in FIG. 2 of the chamber of the solid-foods dispenser of FIG. 1.

### DESCRIPTION OF THE PREFERRED EMBODIMENTS

While the various features of this invention are hereinafter described and illustrated as a solid-foods dispenser comprising an elongate housing having structural walls defining a chamber bounded by terminal ends, it is to be understood that the various features of this invention can be used singly or in various combinations thereof to receive a stick of solid edible material and dispense the material in at least one ribbon of desired thickness as can hereinafter be appreciated from a reading of the following description.

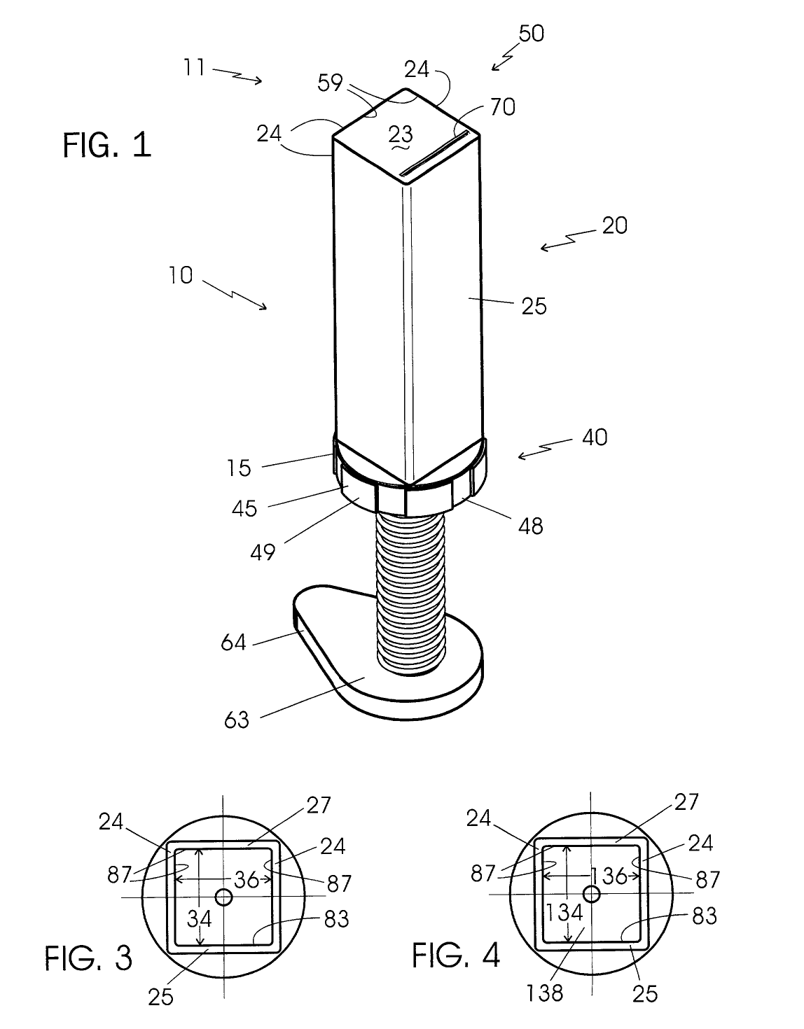

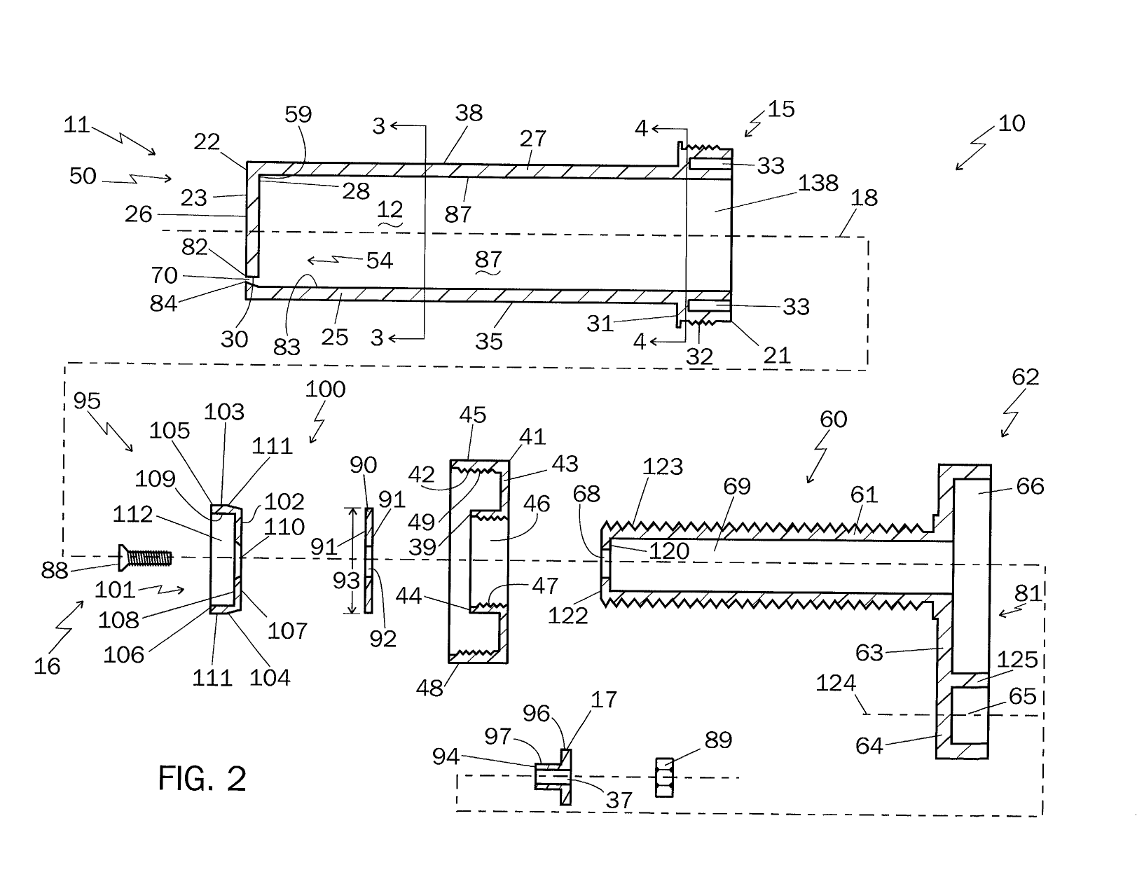

Referring now to FIGS. 1 and 2, the preferred embodiment of the solid-foods dispenser generally described with the numeral 10 is adapted to receive a stick of solid edible material (not shown) and dispense the material in at least one ribbon of desired thickness. Solid-foods dispenser 10 comprises an elongate housing 20 having structural side walls 24, top structural wall 27 and bottom wall 25 defining a chamber 12 bounded by terminal ends 21, 22. Chamber 12 has an internal configuration generally corresponding to the configuration of the stick of material to be dispensed. A first closure means generally shown by the numeral 40 is associated with a loading end 15 of solid-foods dispenser 10 and is adapted to be removingly engaged from open terminal end 21 of housing 20. A second closure means generally described by the numeral 50 comprises a pressure plate 23 carried by housing 20 with a discharge slot 70 associated therewith, pressure plate 23 having an internal face 54 facing toward chamber 12. A plunger means generally described by the numeral 95 is positioned in housing 20 and is movable from a position spaced from second closure means 50 along the longitudinal axis 18 of dispenser 10 to a position adjacent second closure means 50. An advancing means generally described by numeral 60 is associated with first closure means 40, housing 20 and plunger means 95, advancing means 60 operable to move plunger means 95 through housing 20 in the direction of second closure means 50. It has been found by the teachings of this invention that an improvement over the art is achieved when second closure means 50 is positioned substantially adjacent the discharge end 11 of dispenser 10, has a first portion 59 thereof fixed to housing 20 and a second portion 82 spaced from bottom wall 25 of housing 20 thus defining a clearance 84 between a bottom surface 30 on second closure means 50 and the inside surface 83 of bottom structural wall 25 of chamber 12. Clearance 84 is preferably convergingly tapered from chamber 12 toward external face 26 thus defining a discharge slot 70 in second closure means 50 through which at least one ribbon of solid material from the stick is expressed. Preferably first portion 59 of pressure plate 23 is affixed to the inside surface 87 of housing 20 along substantially the breadth of each structural side wall 24 and top structural wall 27 thus providing a buttress to support structural walls 24, 27 of discharge end 11 yet having its bottom surface 30 spaced from inside surface 83 of bottom structural wall 25. Pressure plate 23 generally is contiguous and continuous with structural walls 24, 27 in first portion 59 but pressure plate 23 may be fixed to at least one of structural side walls 24 and/or top structural wall 27 with webs (not shown) extending from inside surfaces 87 thereof. In this preferred embodiment, pressure plate 23 has a external face 26 and an internal face 54, internal face 54 having a planar surface 28.

Plunger means 95 comprises a piston 100, a bearing washer 90 and a retaining means 16. Retaining means 16 typically comprises a tapered head machine screw 88, an insert 17 and a nut 89 wherein machine screw 88 and nut 89 are commercially available hardware items. Preferably, nut 89 is of the jam nut type adapted to be frictionally retained on screw 88 without the aid of locking media. Retaining means 16 affixes piston 100 to one end 122 of a screw shaft 61 of an advancing means 60, screw shaft 61 having a handle 63 associated with the other end 62 thereof. Insert 17 is a shouldered pilot retainer preferably made of thermoplastic material which is frictionally fit within a hole 68 disposed in terminal end 122 of screw shaft 61 wherein insert 17 has its shoulder portion 96 adapted for engagement with an inside surface 120 of terminal end 122 and its pilot portion 97 extending through hole 68. End 94 of pilot 97 extends beyond terminal end 122 slightly more than the thickness of backing washer 90 when insert 17 is fully seated within hole 68 thus cooperating with surfaces 91 to provide for backing support to piston 100. Central hole 37 through insert 17 is adapted to receive machine screw 88 therethrough wherein nut 89 is threaded thereon to assemble piston 100 and backing washer 90 to advancing means 60.

Piston 100 is preferably a substantially square cup like structure wherein its height is equal to its width and wherein each side 111 of piston 100 has a straight portion 103 and a relief portion 104. Straight portion 103 is adjacent an open end 106 thereof wherein the width of piston 100 is substantially equal to the maximum width 34 of major portion 38 of chamber 12 and a breadth substantially equal to the maximum breadth 36 of major portion 38 of chamber 12. Straight portion 103 extends from a knife edge 105 at the juncture of straight edge 103 and open end 106 aft to relief portion 104, relief portion 104 joined to a rear wall 107 of piston 100. Rear wall 107 has a first pressure face 102 on the exterior side thereof and flat internal face 101 on the internal side thereof, flat internal face 101 cooperating with internal walls 109 to form recessed face 112 of plunger means 95. Rear wall 107 further has a bore 110 therethrough, bore 110 having a tapered seat 113 for accepting the tapered head of machine screw 88. As sides 111 of piston 100 are substantially the same dimension as the maximum width 34 and maximum breadth 36 of major portion 38 of chamber 12, knife edge 105 and straight portion 103 combining to provide wiping contact with internal surfaces 83 and 87 of chamber 12 thus removing substantially all of the material of the butter stick along chamber 12 for extruding through discharge slot 70. Thus, it may be said that piston 100 has an interference fit throughout the length of major portion 38 of chamber 12. Though piston 100 preferably has recess 112 therein, piston 100 could be made solid such that recess 112 is not present or recess 112 could be filled with a separate, square block of material having a thickness substantially equal to the depth of recess 112 such that end 106 of piston 100 substantially mates with inside surface 28 of chamber 12.

In the preferred embodiment shown, bearing washer 90 has opposing faces 91, a through hole 92 and an outside diameter 93 of approximately one and one quarter inch. Through hole 92 is slightly larger in diameter than pilot end 97 of insert 17 for a sliding fit thereupon. The thickness of backing washer 90 between opposing faces 91 is approximately one sixteenth inch but may be more or less as long as backing washer 90 can transfer the force from screw shaft 61 through plunger means 95 and effect the extrusion of the solid stick of edible food through discharge slot 70. Bearing washer 90 is disposed intermediate pressure face 102 of piston 100 and terminal end 122 of screw shaft 61 to provide for free rotation of screw shaft 61 while piston 100 translates longitudinally through chamber 12 without rotation. Likewise, though sides 111 are substantially the same as the maximum of width and breadth 36 of major portion 38, the length of sides 111 is preferably smaller than minimum width 134 and minimum breadth 136 of entry portion 138 thus providing for the aforementioned free running fit therein.

It is readily apparent in the preferred embodiment shown in FIG. 2, that recessed face 112 of piston 100 will have a force against flat internal face 101 and against interior surfaces 109 of walls 111 as the stick of solid food is moved into contact with second closure means 50, the force thereby produced will have a tendency to force walls 111 against interior surfaces 83, 87 of chamber 12. As bearing washer 90 is circular and does not contact the entirety of pressure face 102 and as end 122 of screw shaft 61 is also preferably smaller than washer 90, bearing washer 90 also allows side edges 111 of cup shaped piston 100 to be forced against interior surfaces 83, 87 as the force of extrusion bears against the interior surfaces 109 of walls 111 thus ensuring the full wiping contact with interior surfaces 83, 87.

As readily observed in FIGS. 1, 3 and 4, elongate housing 20 is generally rectangular in internal cross section having structural side walls 24, top wall 27 and bottom wall 25 terminating at ends 21, 22. Internal surface 87 of top wall 27 and internal surface 83 of bottom wall 25 are preferably non-parallel surfaces such that housing 20 has an internal height 34 as measured from inside surface 83 of structural wall 25 to a corresponding inside surface 87 of top structural wall 24 that varies throughout a major portion 38 of the length of chamber 12. Likewise, housing 20 has an interior width 36 as measured between inside surfaces 87 of opposing side structural walls 24 that may also vary throughout major portion 38 of the length of chamber 12. Terminal end 21 further has a boss 31 disposed thereon for accepting first closure means 40. Boss 31 extends from terminal end 21 along a portion of the exterior surface 35 of housing 20 and may extend the entire length thereof, however, boss 31 is typically approximately three quarters inch in length and has threaded external periphery 32 formed thereon. Threaded external periphery 32 generally has an triple lead screw thread for rapid mounting and removal of first closure means 40 although a thread having a different number of leads is fully within the scope of this invention. Boss 31 may have recesses 33 disposed therein from terminal end 21 to lessen the weight of housing 20 and hence dispenser 10. Non-parallel surfaces 83, 87 may be tapered or curved from end 21 to end 22 throughout major portion 38 and likewise may be tapered or curved in entry portion 138. For ease of manufacture, it is preferred that interior surfaces 83, 87 converge toward closed end 22. Thus, maximum height 34 and/or maximum width 36 of interior surfaces 83, 87, is measured closest to end 22 of major portion 38. If a radius is used, the center of the chord would generally lie close to a plane parallel to and substantially at end 11 though the chord could be displaced from that plane without departing from the scope of this invention. It is fully understood here, that only one surface 83, 87 need be made non-parallel to comply with the intent of the inventors hereof.

Referring specifically to FIG. 4, an enlarged entry portion 138 is provided to facilitate placement of piston 100 within chamber 12 at assembly of dispenser 10. Internal surface 87 of top wall 27 and internal surface 83 of bottom wall 25 in entry portion 138 are preferably also non-parallel walls such that housing 20 has an internal height 134 in entry portion 138 as measured from inside surface 83 of structural wall 25 to a corresponding inside surface 87 of top structural wall 24 that may vary throughout a entry portion 138 of chamber 12. Likewise, housing 20 has an interior width 136 in entry portion 138 as measured between inside surfaces 87 of opposing side structural walls 24 that may also vary throughout entry portion 138 in entry portion 138 of chamber 12. Thus, in entry portion 138, piston 100 may be described as having a loose running fit with chamber 12 where there is generally a clearance between each edge of piston 100 and each of structural walls 24, 25 and 27 only in entry portion 138. Though it is preferred that at least one of interior surfaces 83, 87 of entry portion 138 vary throughout entry portion 138, it is not necessary and thus walls 83, 87 may be parallel within entry portion 138. As the stick of butter to be placed in chamber 12 is usually approximately the length of major portion 38, there is no need for wiping contact within entry portion 138.

As discharge slot 70 is through one planar surface 28 of pressure plate 23 and cup shaped piston 100 forces substantially all of the solid material against pressure plate 23, discharge slot 70 dispenses at least one ribbon of solid edible material through discharge slot 70. Preferably, discharge slot 70 spans across the width of pressure plate 23 adjacent structural bottom wall 25 and thus the ribbon of material discharged from discharge slot 70 has a width substantially greater than the thickness thereof through said discharge slot. Though it is preferred that dispenser 10 has a straight slot as discharge slot 70, discharge slot 70 may comprise multiple ports thereby dispensing a ribbon of material comprising multiple streams of solid edible material therethrough. The multiple ports may be of any desired configuration, for example, each of the multiple ports may have a width substantially equal to the thickness thereof, though it is contemplated that each of the multiple ports may have any geometrical configuration and may or may not be interconnected. Geometrical configurations may include quarter rounds, half rounds, polygons, split tubes, spaghetti shapes and/or an undulating shape. Discharge slot 70 is disposed adjacent bottom structural wall 25 so that the ribbon of material exuding from discharge slot 70 is generally directed parallel to axis 18 of dispenser 10. In this manner, the ribbon of material may be directed to a substrate while generally holding dispenser 10 in any orientation from parallel to perpendicular relative to the substrate. Since pressure plate 23 is affixed to inside surfaces 87, pressure plate 23 accepts and bears the extruding force on the solid edible material generated by advancing means 60.

Preferably, chamber 12 of housing 20 is convergingly tapered from loading end 15 to discharge end 11 of dispenser 10 as structural walls 24, 25, forming chamber 12 are all convergingly tapered on inside surfaces 87, 83 respectively from open terminal end 21 to other terminal end 22 throughout the length 14 thereof. The taper of structural walls 24, 25 is less than two degrees and is preferably less than one degree. Chamber 12 as shown in FIG. 2 when used for butter or margarine is substantially square in interior configuration and therefore each dimension 34, 36 is approximately one and three-eighths inch at open terminal end 21 while dimension 34, 36 at other terminal end 22 more closely match the dimensions of the stick of butter or margarine at one and one quarter inch each. Thus, over the length 14 of chamber 12, the taper of each wall is more preferably about six tenths of one degree. Although chamber 12 is shown as substantially square, the interior width 36 may be greater than the internal height 34 in order to accommodate a stick of solid edible food of unequal rectilinear dimensions.

Referring now to FIGS. 1 and 2, first closure means 40 comprises an end cap 41 having internal threads 42 adapted to be threadingly engaged upon open terminal end 21 of elongate housing 20, first closure means 40 receiving a screw shaft 61 of advancing means 60 in a hole 46 in the center thereof. Internal threads 42 have a multiple lead adapted for rapid removal of first closure means 40 from elongate housing 20. First closure means 40 comprises an end cap 41 having internal threads 42 disposed on the inside of a peripheral wall 49, peripheral wall 49 bounded by an end wall 43. Internal threads 42 of first closure means 40 are typically a triple lead screw thread adapted to mate with threaded external periphery 32 of boss 31 on the loading end 15 of housing 20. A thread having a different number of leads is fully within the scope of this invention as long as the lead and thread match between threaded external periphery 32 and internal threads 42. The triple lead thread allows for rapid removal of advance means 60 from dispenser 10. Outer surface 45 of peripheral wall 49 has flats 48 disposed thereon for ease of gripping while removing end cap 41. Hole 46 is disposed through end wall 43 and an internal boss 39, internal boss 39 formed integrally with end wall 43 having an internal face 44 opposite end wall 43. Hole 46 has threads 47 formed therein, threads 47 adapted to mate with external threads 123 on shaft 61 of advance means 60. In the preferred embodiment, threads 47 are 1-8 UNC machine threads however any suitable thread is within the scope of this invention. Threads 47 are shown as extending completely through internal boss 39 and end wall 43 from internal face 44 to external face 43 to provide for rotational stability for shaft 61 however, threads 47 could be disposed only in end wall 43 or only within internal boss 39. Thus, removable first closure means 40 has advance means 60 associated therewith, advance means 60 having a plunger means 95 on a terminal end 122 thereof wherein plunger means 95 is adapted to be positioned in housing 20 and movable along the longitudinal axis 18 of dispenser 10, advance means 60 forcing at least one solid stream of a stick of solid edible material through discharge slot 70. Advance means 60 as shown in FIG. 1 comprises a threaded screw shaft 61 having a terminal end 122 spaced from a handle end 62, terminal end 122 having plunger means 95 rotationally affixed thereto with backing washer 90 disposed between terminal end 122 and plunger means 95. Terminal end 122 has insert 17 disposed therein having its shoulder portion 96 abutting a vertical internal wall 120 of terminal end 122, insert 17, screw 88 and nut 89 adapted to retain plunger means 95 upon terminal end 122.

Handle end 62 of advance means 60 comprises handle 63 having a prolate offset 64 with a finger hole 65 adjacent a recess 66, recess 66 and finger hole 65 disposed into handle 63 from an open end 81 thereof with through hole 69 formed through open end 81 extending though shaft 61 to internal wall 120 of terminal end 122. Thus, shaft 61 is hollow for ease of manufacture as well as material and weight savings. Finger hole 65 is approximately five eighths inch in diameter having its center line 124 approximately two inches from axis 18 with a web 125 separating finger hole 65 from recess 66. Thus, finger hole 65 functions as an offset crank allowing for rapid advance of shaft 61 through end cap 41 while providing mechanical advantage means for advancing the stick of solid foods through chamber 12.

Referring again to FIGS. 1 and 2, dispenser 10 is assembled by first threading shaft 61 through end cap 41 by inserting terminal end 122 into hole 46 from end wall 43 with terminal end 122 extending beyond internal face 44 of end cap 41. Finger hole 65 may be utilized to spin advance means 60 within threads 47 through hole 46 or end cap 41 may be spun upwardly on shaft 61 as a nut is spun onto a threaded shaft in a conventional manner. At assembly of advancing means 60, insert 17 has pilot 96 inserted into hole 68 through through hole 69 from handle end 62, end cap 41 is threaded upon threads 123, screw 88 of retaining means 16 is passed through bore hole 110 in piston 100, hole 92 in washer 90 and into hole 37 in insert 17. Screw 88 fits closely within insert 17 and can be threaded into the thermoplastic of hole 37 to temporarily retain piston 100 upon terminal end 122. Thereafter, nut 89 is passed through hole 69 in shaft 61 and threaded upon the open end of screw 88 to firmly retain piston upon terminal end 122. Backing washer 90 should abut pressure face 102 of piston 100 and be in close contact with terminal end 122 when retaining means 16 is tightened to have shoulder portion 96 abut internal wall 120. Thus, first closure means 40 is fully assembled and ready for mounting within and upon open terminal end 21 of housing 20.

In operation, dispenser 10 has first closure means 40 removed from end 21 and a stick of solid edible material inserted into open terminal end 21 of housing 20, the solid stick adapted to slide freely toward pressure plate 23 abutting internal face 54. First closure means 40 is brought into proximity with open terminal end 21 of housing 20 and plunger means 95 is inserted into chamber 12 with mating face 101 facing the stick of solid edible material. As enlarged portion 138 readily receives piston 100 therein, end cap 41 of first closure means 40 may easily be threaded upon threaded external periphery 32 of boss 31, threads 42 rapidly advancing upon threaded external periphery 32 as these cooperating threads are generally triple lead threads. Rotation of advance means 60 then moves plunger means 95 into contact with the stick of solid edible material and toward pressure plate 23 sufficiently to ensure that the stick of solid edible material bears firmly against internal face 54. Once fully readied for use, dispenser 10 is brought in proximity with the surface of a substrate such as toast and handle end 62 of advance means 60 is rotated utilizing finger hole 65 thereby pressing plunger means 95 against the stick of solid edible material. As pressure increases, walls 111 of plunger means 95 may deform slightly as plunger 95 is inserted into and moved through chamber 12 as internal surfaces 109 are forced outwardly due to the increasing pressure of the solid edible foods bearing thereagainst thereby promoting the aforementioned wiping force against walls 83, 87 thereof. The force of plunger means 95 against the solid stick presses the stick against pressure plate 23 that causes a portion of the stick to be exuded through discharge slot 70 substantially parallel to longitudinal axis 18 of dispenser 10 and onto the substrate. As dispenser 10 is moved along the substrate, a ribbon of solid material is laid upon the substrate as desired. Upon laying down the desired amount, rotation of handle end 62 is ceased causing the flow of solid material to be interrupted. As the solid edible material possesses little strength in a thin ribbon, the ribbon of material may be easily broken by rotating dispenser 10 upwardly away from the substrate, wiping terminal end 22 upon the substrate or by withdrawing dispenser 10 from the area of the substrate in a direction parallel to the axis 18 of dispenser 10. Hence there is no need slice off the protruding portion of the solid stick of edible material with a knife as is prevalent in the prior art.

After breaking the ribbon, another ribbon may be laid down on the substrate or dispenser 10 may be laid aside for later use. Preferably, when a use of dispenser 10 is completed, it is advantageous to rotate handle end 62 in a counterclockwise direction slightly to remove the pressing force against pressure plate 23 to prevent an additional amount of solid edible material from exuding through discharge slot 70 while dispenser is not is use. When dispenser 10 is empty and a new stick of solid material needs to be inserted, first closure means 40 may be rapidly removed from housing 20 by unscrewing end cap 41 and withdrawing advance means 60 from chamber 12. After removal of first closure means 40, end cap 41 may be spun downwardly toward plunger means 95 in order to ready first closure means 40 for placement within chamber 12 upon placing the new stick of solid edible material therewithin, Thus, before beginning the next discharge operation, the need to back out the threaded shaft entirely through the closure before removing the closure is avoided. End cap 41 is spun downwardly as a nut is spun upon a threaded shaft and as end cap 41 was spun upwardly upon shaft 61 at assembly of advance means 60. There is no need to clean the screw shaft 61 as in the prior art as the shaft does not penetrate the stick.

In a method of making a solid-foods dispenser 10 adapted to receive a stick of solid edible material and dispense the material in a solid stream onto a substrate, dispenser 10 is formed as an elongate housing 20 having structural walls 24, 25 bounded by terminal ends 21, 22, one of terminal ends 21, 22 defining a loading end 15 of dispenser 10, the one terminal end 21 having first removable closure means 40 associated therewith, the other terminal end 22 defining a discharge end 11 of dispenser 10, other terminal end 22 having a first portion 59 thereof fixed to housing 20 and a second portion 82 spaced from bottom wall 25 of housing 20 thus defining a clearance 84 between a bottom surface 30 of a second closure means 50. Clearance 84 is preferably a convergingly tapered slot having its narrowest portion substantially at external surface 26 of pressure plate 23 thus defining discharge slot 70 at external surface 26. As first portion 59 is affixed to and integral with housing 20, portion 59 defines a pressure plate 23 formed within housing 20. Referring to FIGS. 1 and 2, elongate housing 20 may be injection molded from a thermoplastic material into a substantially rectilinear tube having pressure plate 23 formed in terminal end 22 thereof, pressure plate 23 substantially closing terminal end 22 while a boss 31 is formed upon the exterior surface 35 of open terminal end 21. Threads for threaded external periphery 32 are formed upon boss 31 during the injection process as the mold cavity is split longitudinally along axis 18, one half of the mold forming threads upon one half of housing 20 while the other half of the mold forms threads upon the other half of housing 20. Chamber 12 is formed within housing 20 by a cantilevered insert corresponding to chamber 12 having the exterior halves of the mold closed thereover. The cantilevered insert has a protrusion on its free end adapted to form convergingly tapered clearance 84 and thus discharge slot 70. The cantilevered insert also preferably has at least one tapered surface generally tapered approximately one eighth inch per foot or about six tenths of one degree thereby forming a taper on at least one of inside surfaces 87, 83 on structural walls 24, 25 respectively. Thus, housing 20 is formed in a closed cavity and removed therefrom by first splitting the mold along axis 18 leaving housing 20 suspended on the cantilevered fixed portion of the mold. Housing 20 may then be removed from the cantilevered portion of the mold by withdrawing housing 20 therefrom.

Plunger means 95 is formed from an elastomeric material and comprises a piston 100 with a recess 112. Plunger means 95 is typically injection molded or transfer molded from a high durometer thermoplastic elastomer such as a fluoroelastomer, silicone, urethane, halogenated polymer, polypropylene, polyethylene, HDPE, LDPE, or other food grade elastomeric material. Piston 100 of plunger means 95 is formed in a blind cavity machined into one half of a mold with a pin extending upwardly for screw hole 110. A flat plate is closed over the blind cavity defining rear pressure face 102. Upon injection of the elastomer into the cavity, the mold is split into the two parts at rear pressure face 102 and piston 100 removed therefrom.

Backing washer 90 may be obtained from machine shops and hardware outlets carrying a thermoplastic or 18-8 stainless steel flat washers. Backing washer 90 is typically a three-eighths inch bolt size flat washer having the inside diameter of through hole 92 equal to about 0.400 of an inch and may be the aforementioned stainless steel washer or may alternately be made from thermoplastic or other metallic material. Alternately, backing washer 90 may be formed from a thermoplastic rod having through hole 92 drilled centrally therethrough with a cup shaped portion corresponding to the length and diameter of protruding portion 121. Thus, backing washer 90 may rotate freely upon pilot 97 of insert 17.

Advance means 60 is formed as an elongate tube having a hollow shaft 61 with threads 123 formed upon the external surface thereof and a through hole 69 formed centrally therein. Referring to FIGS. 1 and 2, advance means 60 may be injection molded from a thermoplastic material into a circular tube having handle end 62 formed on one end thereof, handle end 62 comprising a handle 63 with a prolate offset 64 formed eccentrically from the axis 18. Handle 63 further has a recess 66 formed in the major portion thereof with web 125 separating recess 66 from finger hole 65. In order to mold advance means 60 a mold cavity is split longitudinally along center line 19, one half of the mold adapted for forming threads 123 on one half of shaft 61 while the other half of the mold is adapted to form threads 123 upon the other half of shaft 61. Through hole 69 is formed within shaft 61 by a rod like slide inserted into the closed mold cavity from an end of the mold forming handle 63. The rod like slide has a reduced end portion opposite handle 63 for forming hole 68 in terminal end 122 and has enlarged portions at handle end 62 for forming recess 66 and finger hole 65. Thus, advance means 60 is formed in a closed cavity and removed therefrom by first retracting the rod like slide forming through hole 69, recess 66 and finger hole 65 and then splitting the mold along axis 19 leaving advance means 60 lying in one half of the mold. Advance means 60 may then be readily removed from the mold half.

End cap 41 of first closure means 40 is injection molded in a blind cavity having the outer surface 45 and the back of end wall 43 machined into the blind cavity. Flats 48 are likewise formed in the cavity in the portion of the cavity forming outer surface 45. A threaded insert for forming threads 42 on the inside of peripheral wall 49 is placed into the mold cavity, the threaded insert having a recess for forming internal boss 39 and internal face 44 machined thereinto. An internal cylinder forms one wall of the recess, the internal cylinder forming hole 46 thereupon. The mold cavity is closed and thermoplastic material is injected thereinto forming end cap 41. Upon completion of the molding process, the mold is opened and end cap 41 withdrawn with the threaded insert. End cap 41 is threadingly removed from the threaded insert and threads 47 are machined into hole 46.

While the present invention has been described with reference to the above described preferred embodiments and alternate embodiments, it should be noted that various other embodiments and modifications may be made without departing from the spirit of the invention. Therefore, the embodiments described herein and the drawings appended hereto are merely illustrative of the features of the invention and should not be construed to be the only variants thereof nor limited thereto.

We claim:

1. In a solid-foods dispenser adapted to receive a stick of solid edible material and dispense the material in at least one ribbon of desired thickness, said solid-foods dispenser comprising an elongate housing having structural walls defining a chamber bounded by terminal ends, said chamber having an internal configuration generally corresponding to the configuration of the stick of material to be dispensed, a first closure means associated with a loading end of said solid-foods dispenser and adapted to be removingly engaged from the open terminal end of said housing, a second closure means carried by said housing, said second closure means having an internal face facing toward said chamber, a plunger means positioned in said housing and movable from a position spaced from said second closure means along the longitudinal axis of said dispenser to a position adjacent said second closure means, advancing means associated with said first closure means, said housing and said plunger means, said advancing means operable to move said plunger means through said housing in the direction of said second closure means, the improvement wherein said second closure means is positioned substantially adjacent the discharge end of said dispenser having a first portion of said second closure means affixed to said housing and a second portion of said second closure means spaced from a bottom wall of said housing thus defining a discharge slot between said second portion of said second closure and said bottom wall of said chamber, said first portion fixed to an inside surface of said housing providing a buttress to support said structural walls of said discharge end.

2. A solid-foods dispenser as in claim 1 wherein said dispenser dispenses at least one ribbon of solid edible material having a width substantially greater than the thickness thereof through said discharge slot.

3. A solid-foods dispenser as in claim 1 wherein said discharge slot comprises multiple ports thereby dispensing a ribbon comprising multiple streams of solid edible material through said discharge slot, each said stream selected from the group comprising quarter rounds, half rounds, polygons, split tubes, spaghetti or an undulating shape.

4. A solid-foods dispenser as in claim 1 wherein said plunger means comprises a piston, a bearing washer and a retaining means, said piston being affixed with said retaining means to one terminal end of a screw shaft of an advancing means, said screw shaft having a handle associated with the other end thereof.

5. A solid-foods dispenser as in claim 4 wherein said piston has a straight portion adjacent an open end thereof wherein the width thereof is substantially equal to the width of the major portion of said chamber and a breadth substantially equal to the breadth of said major portion of said chamber.

6. A solid-foods dispenser as in claim 5 wherein said straight portion combines with a knife edge on the open end of said piston for wiping surface contact with the interior surfaces of said major portion of said chamber.

7. A solid-foods dispenser as in claim 4 wherein said plunger means has said bearing washer being disposed intermediate a pressure face of said piston and said terminal end of said screw shaft.

8. A solid-foods dispenser as in claim 4 wherein said piston has a recess in the open end thereof.

9. A solid-foods dispenser as in claim 1 wherein said first closure means comprises an end cap having internal threads adapted to be threadingly engaged upon an open end of said elongate housing, said closure means receiving a screw shaft of said advancing means in a threaded hole in the center thereof, said internal threads having a multiple lead adapted for rapid removal of said first closure means from said elongate housing.

10. A solid-foods dispenser as in claim 1 wherein said chamber has at least one interior surface thereof that varies in distance with respect to a corresponding opposing interior surface.

11. A solid-foods dispenser as in claim 10 wherein said at least one said interior surface of said chamber converges from said open terminal end to said discharge terminal end thereof.

12. A solid-foods dispenser as in claim 11 wherein said at least one said interior surface of said chamber is tapered.

13. A solid-foods dispenser as in claim 12 wherein the taper of said at least one said interior surface is preferably less than two degrees.

14. A solid-foods dispenser as in claim 13 wherein said taper of said structural walls is preferably six tenths of one degree.

15. In a solid-foods dispenser adapted to receive a stick of solid edible material and dispense the material in a solid stream onto a substrate, said dispenser comprising an elongate housing having rectilinear structural walls bounded by terminal ends, one of said terminal ends defining a loading end of said dispenser, said one terminal end having removable closure means associated therewith, the other of said terminal ends defining a discharge end of said dispenser, said other terminal end having a portion of said closure means fixed to and integral with said housing, the improvement wherein said portion defines a pressure plate within said housing for bearing the force of extrusion of said solid edible material, said pressure plate fixed to an inside surface of said housing providing a buttress to support said structural walls of said discharge end.

16. A solid-foods dispenser as in claim 15 wherein said pressure plate defines at least one discharge slot between said portion of said closure means fixed to said housing and an interior surface of one of said structural walls.

17. A solid-foods dispenser as in claim 16 wherein said removable closure means has advance means associated therewith, said advance means having a plunger means on one end thereof positioned in said housing and movable along the longitudinal axis of said dispenser, said advance means forcing at least one solid stream of said stick of solid edible material through said discharge slot.

18. A solid-foods dispenser as in claim 17 wherein said solid stream is a ribbon of desired thickness having a width substantially greater than the thickness thereof.

19. A solid-foods dispenser as in claim 17 wherein said at least one said discharge slot comprises multiple discharge ports thereby dispensing a ribbon comprising multiple streams of solid edible material each said stream having a width substantially equal to the thickness thereof.

20. In a solid-foods dispenser adapted to receive a stick of solid edible material and dispense the material in at least one ribbon of desired thickness, said solid-foods dispenser comprising an elongate housing having structural walls bounded by terminal ends defining a chamber, said chamber having an internal configuration generally corresponding to the configuration of the stick of material to be dispensed; a first closure means removably associated with a loading end of said dispenser, said first closure means having an advance means associated therewith; a second closure means on a discharge end of said dispenser having die means associated therewith, a plunger means positioned in said housing and movable from a position spaced from said second closure means along the longitudinal axis of said dispenser to a position adjacent said second closure means, said advance means moving said plunger means, the improvement wherein said chamber is convergingly tapered from said loading end to said discharge end throughout the length thereof.
